(19) United States
(12) Patent Application Publication
(10) Pub. No.: US 2009/0281903 A1
(43) Pub. Date: Nov. 12, 2009

(54) System for Ordering Items by a User in a Limited Venue

(75) Inventor: Eric Jay Blatstein, Newtown, PA (US)

Correspondence Address: FLASTER/GREENBERG P.C.;Four Penn Center, 1600 John F. Kennedy Boulevard, 2nd Floor, PHILADELPHIA, PA, 19103, US

(73) Assignee: OTG Management, Inc., Philadelphia, PA (US)

(21) Appl. No.: 12/418,115

(22) Filed: Apr. 3, 2009

Related U.S. Application Data
(60) Provisional application No. 61/052,616, filed on May 12, 2008.

(51) Int. Cl. G06Q 30/00; G06Q 50/00; G06Q 20/00

(52) U.S. Cl. 705/15; 705/26; 705/17

(57) ABSTRACT

The present invention is directed to a system, a gate hold area and methods for a user to order an item in a limited venue for delivery to the limited venue using a kiosk having a computer and ordering software in communication via a network to a transaction server. The orders are prepared in an order preparation area and delivered to the limited venue area. The limited venue may be a gate hold area and a media server for providing real time information relevant to the venue may also be provided herein.

### CROSS-REFERENCE TO RELATED APPLICATIONS

This application claims priority under 35 U.S.C. § 119(e) to U.S. Provisional Patent Application No. 61/052,616, filed May 12, 2008 having the title, “System for Ordering Items by a User in a Limited Venue, the entire disclosure of which is incorporated herein by reference.

### BACKGROUND OF THE INVENTION

1. Field of the Invention

The invention concerns automated systems and methods for ordering items from a limited holding venue from a given selection of items for delivery to the limited holding venue within a fixed period of time, particularly for limited holding venues encountered during traveling.

2. Description of Related Art

Based on the increased amount of time patrons must spend in venues such as airports, train stations, bus depots and the like, and due to increased security, areas such as gate hold areas and other limited seating and/or waiting areas have become an important component of the overall travel experience. Many patrons rush to the gate hold area in fear of missing their flights attempting to take into account the unpredictable time that may be required for passing through security checkpoint or search areas and/or because they need to check in with the flight attendants at the gate for flight seating, flying standby and other similar reasons. Others proceed quickly to the gate hold area so they can attempt to access the small number of available electrical outlets to “power up” electronic components, such as laptops, phones and PDAs before a flight. Further, gate hold areas are the last point of contact with departing customers before they leave the terminal and have limited or no communication availability. Once in the holding area, and especially when flights are delayed, passengers and other customers may feel trapped in the holding area for significant periods of time causing discomfort, inconvenience and lost business time.

Travelers often have difficulty accessing food, drink and other resources once they arrive in a gate hold area. While food and other supplies are available in many airport concourses, selections are more severely limited once passengers enter the gate hold area and/or what food and other access is available past the security point may be located far from the area where passengers are assigned to sit and wait for flights. Another problem is that it is difficult to shop and/or go to restaurants and/or concessions when travelers are alone and/or encumbered. For example, passengers with heavy carry-on luggage that cannot be left unattended and/or who are traveling with small children, or both, often avoid concession stands and food court areas in airport concourses or in the areas just behind security prior to the waiting area of the gate hold area, because it is difficult to deal with luggage or restless children while waiting in line for food concession stands or in restaurants in the concourse. This problem is compounded by the use of flimsy trays to carry the food and drink to where it can be consumed and/or the risk of being distracted and robbed while juggling food, bags and/or children. Further, concessions stands and restaurants which have the desired food and beverages may be located outside the gate hold area of the venue outside of the security checkpoint, thus requiring re-entry through security if the gate is left, something which is highly discouraged once the security area is entered. Moreover, the plight of the hungry air traveler is further compounded by the continuing reduction of in-flight food service throughout the airline industry.

Business travelers have the additional problem of relinquishing their outlet connection for their electronic devices in the gate hold area if they desire to obtain food or drink or other sundries or even if they just walk away to use the restroom. Once they have moved away, the chances are great that someone else will start to use the outlet, leaving them in a difficult situation. Thus, the loss of productivity associated with necessary business travel is compounded by the lack of a suitably equipped and designated area in such limited holding venues that not only has the necessary components for using electronic devices but also allows for the user to obtain refreshments or needed sundries and/or walk away and still have an available work space for continuing business activities upon their return.

WO2005/015463 A1 teaches integration of ordering, payment and delivery services in an establishment. The system involves providing screens where a customer inputs an order from an on-screen menu and is given in response to the order an estimated time of arrival for the delivery of the ordered items. The system can also include feedback to servers who deliver items when the orders are ready. Payments are made by credit card and special features described include advertising, special offers, credit card offers, games between users, interaction with mobile phones and visual media, and banking. Types of establishments where the system may be used, in establishments such as on airplanes and in the duty-free shopping area of airports, to allow for delivery of goods upon arrival to avoid lugging purchased items from place to place.

U.S. Publication No. 2007/0265935 A1 describes a computer-based ordering system available from NEXTEP SYSTEMS® for ordering goods and services using a plurality of self-service ordering terminals and a server. The self-service ordering includes an interactive menu with buttons for selecting and customizing an order. The system includes an administrative tool application that administers the orders from the self-service terminals, which allows for editing and modification of orders and menu screens. Such systems have been demonstrated in fast food restaurant play areas and near swimming pools where customers can order food and items.

U.S. Publication No. 2005/0015301-A1 is directed to a “smart” food court. Restaurants are described as including fast food-type restaurants, sit-down establishments, coffee shops, etc. Payments may be by cash, debit, etc. with capacity to honor coupons and other deals. Users can make orders while the user remains in a particular location such as seated within a restaurant. Menu selections are input through a touch screen. When an order is complete, a user can take a receipt to a designated restaurant and pickup the food or use an automated delivery system.

U.S. Pat. No. 6,920,431 teaches a method of remote ordering for large venue areas such as stadia, convention halls and airports. The system includes a touch pad for ordering food for delivery to a specifically identifiable location (such as a numbered stadium seat or particular gate location). Patrons may use hand-held ordering equipment and/or wireless devices such as cell phones to input ordering information. When an order is complete, a “runner” delivers the order to the user. For more open areas, an Internet address or GPS through a cell phone can be used to identify a location of a patron instead of designated seat/row or gate number.

While there are advances in this area, there is still a need in the art for systems and methods that allow patrons in limited holding areas and venues, particularly, airports, train stations and the like, to order food, drinks and other items for delivery while waiting and/or sitting in a comfortable environment that accommodates the user's need for information regarding transportation, while providing sufficient work areas and/or well-equipped support for conducting business and/or using electronic devices.

### BRIEF SUMMARY OF THE INVENTION

The need is met by furnishing designated limited venue areas that have seating and include an interactive ordering system for food, drink and other items, which are obtainable from a designated location. The system may also include a media server for providing for the display of real-time information that is transmitted directly from the venue.

The invention includes a system for a user in a venue to order an item for delivery to the venue, comprising: at least one kiosk, having a display screen and a computer having software capable of processing an order, the kiosk being located in a limited venue; at least one seat located in the limited venue; a network; a transaction server in communication with the computer in the kiosk via the network; and an order preparation area having a display device in communication with the transaction server via the network.

Each kiosk in the system may comprise an identifier. The computer software of the kiosk may be configured so as to enable users to select at least one item to complete an order to be prepared in the order preparation area.

The system may further comprise a media server. The network of the system may be a wireless network or hard wired.

The limited venue in the system can be selected from a group consisting of a gate hold area of an airport, a bus depot waiting area, a train station boarding area, a hospital waiting area, a medical center waiting area, a park, or a waiting area of a shopping mall. In one preferred embodiment, the system may have a limited venue that is a gate hold area of the airport.

In another embodiment of the invention, the system may also comprise at least one outlet and/or multiple seats having at least one of a row seating arrangement, an arrangement around a table, an arrangement in a form of a pod, a counter seating arrangement, and an individual seat. In a further embodiment, there are multiple kiosks and seats, and each of the kiosks is available to at least two of the seats.

The transaction server of the system in preferably capable of communicating estimated ordering time to the kiosk for the user to review. In one embodiment, the order preparation area in the system can provide an item from at least one vendor. The vendor(s) may be a restaurant, gift shop, newsstand and/or a bar.

The kiosk in an embodiment may further comprise a payment device, which may include a magnetic swiping device.

The invention also includes gate hold area, comprising at least one kiosk, having a display screen and a computer having software capable of processing an order, the kiosk being located in the gate hold area; and at least one seat located in the gate hold area; wherein the computer of the at least one kiosk is capable of communicating item ordering information via a network to a transaction server which is also in communication with at least one display device in at least one order preparation area for processing an order transmitted from the at least one kiosk.

In one embodiment, the gate hold area has at least one kiosk, which is also in communication with a media server via a network for providing gate hold information to a user.

The kiosk of the gate hold area may in another embodiment hereof further comprise an identifier, a payment device and/or a receipt printer.

The table and seating options where kiosks are located in a gate hold area may also comprise electrical outlets.

In another embodiment, the kiosk of the gate hold area further comprises software capable of generating sales and revenue data information for communication to the transaction server. The kiosk may also have a display screen capable of displaying information from the media server and ordering information from a transaction server. The kiosk in the gate hold area may also optionally be capable of receiving an estimated order preparation time from a transaction server.

The gate hold area may also comprise at least one vendor within the gate hold area, wherein the at least one vendor is, for example, a restaurant, a gift shop, a newsstand, or a bar.

In one embodiment of the gate hold area, the computer of the at least one kiosk is capable of communicating item ordering information via a network to a transaction server which is also in communication with at least one display device in at least one order preparation area for processing an order transmitted from the at least one kiosk and for transmitting an estimated order delivery time to the at least one kiosk prior to acceptance of an order by a user.

Food preparation area(s) may be located inside or outside of the gate hold area.

In a further embodiment of the gate hold area, each kiosk comprises an identifier and is located in an area of the gate hold area wherein a user waits for an order processed through the kiosk to be delivered.

The gate hold area may also be arranged such that the area comprises multiple seats having at least one of a row seating arrangement, an arrangement around a table, an arrangement in a form of a pod, a counter seating arrangement, and an individual seat.

The gate hold area may further be configured so as to have multiple kiosks and seats, and each of the kiosks is available to at least two of the seats.

The invention further includes a method for a user to order an item in a limited venue for delivery to the limited venue, comprising: (a) providing a limited venue comprising at least one seat, and at least one kiosk having a display screen and a computer having software capable of processing an order, wherein the kiosk is capable of displaying a selection of items to the user; (b) selecting an item from the selection of items to complete an order; (c) transmitting the order from the kiosk via a network to a transaction server; (d) transmitting ordering information back to the user from the transaction server via the network to the kiosk for acceptance of the order by the user; (e) submitting the accepted order to the transaction server via the network; (f) transmitting the accepted order from the transaction server to an order preparation area via the network; (g) completing the order; (h) paying for the order; and (h) delivering the order to the limited venue.

In one embodiment of the method, ordering information that is transmitted back to the user in step (d) comprises estimated order delivery time, order item information, and order item cost information.

The method, in a further embodiment may comprise providing an option to the user to include a gratuity within an overall cost of an order when accepting the order.

In another embodiment of the method, step (h) further comprises paying for the order via a payment device on the kiosk.

In addition the method may be modified such that in step (c), the method further comprises submitting a kiosk identifier and/or an order identifier and/or user identifier along with item order information to the transaction server from the kiosk via the network.

In another method embodiment, step (f) further comprises transmitting the order information to more than one order preparation area.

The method may also be such that step (f) further comprises receiving the transmitted order information in the order preparation area via a display device.

The method may also be carried out in an embodiment in which the method further comprises providing venue information to the kiosk for user review from a media server.

The method may also comprise communicating with the computer in the kiosk via a wireless or remote access source to interface with the computer. The wireless or remote access source may be an individual user computer, PDA or wireless phone. The network may be wireless, and the method may further comprise monitoring status of the order via the kiosk after the order has been accepted.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic representation of an embodiment of a system according to the present invention;

FIG. 2 is a schematic representation of the system of FIG. 1, when the network has a wireless network configuration;

FIG. 3 is schematic representation of a gate hold area according to an embodiment of the present invention;

FIG. 4A is a top schematic plan view of a pod seating configuration for use in an embodiment of a system or gate hold area according to the invention;

FIG. 4B is a top schematic view of a second seating configuration for use in an embodiment of a system or gate hold area according to the invention;

FIG. 4C is a side view of the table seating configuration of FIG. 4B taken along line 4C-4C;

FIG. 5 is a flowchart showing steps in a method according to an embodiment of the present invention;

FIG. 6 is a representative illustration of a exemplary introductory menu screen for initiating ordering according to a method of an embodiment of the invention;

FIG. 7 is a representative illustration of an initial menu screen presenting various categories of menu items from a general menu on a kiosk according to the method embodiment initiated in the screen shown in FIG. 6;

FIG. 8 is a further representative illustration of a screen showing one of the specific menu choices (sandwiches available) within a category (sandwiches) of the available menu choices on a kiosk as shown in FIG. 7;

FIG. 9 is a further representative illustration of a screen showing one of the specific menu choices (desserts available) within a further category (desserts) of the available menu choices on a kiosk as shown in FIG. 7;

FIG. 10 is a further representative illustration of a screen showing one of the specific menu choices (beverages available) within a further category (beverages) of the available menu choices on a kiosk as shown in FIG. 7;

FIG. 11 is a further representative illustration of a screen showing a more specific selection of items (particular cold beverages available) within a sub-category (cold beverages) of the beverage category in the embodiment shown in FIG. 10;

FIG. 12 is a further representative illustration of a screen showing on of the specific menu choices (small plates available) within a further category (small plates) of the available menu choices on a kiosk as shown in FIG. 7 with the option also of adding an alcoholic beverage to the order;

FIG. 13 is a further representative illustration of a screen showing an age inquiry and request to show identification for a user in the event the user elects to select the alcoholic beverage in the embodiment shown in FIG. 12;

FIG. 14 is a further representative illustration of a screen allowing a user the option to add a gratuity to the user's order for processing the order selected using the menu categories shown in FIG. 7 and specific user category and sub-category menu screens as shown, for example, in FIGS. 8-12;

FIG. 15 is a further representative illustration of a screen showing calculation of a proposed order including total cost of menu items, tax and gratuity, and instructing the user to pay by credit card through a credit card swiping device for paying for and completing the order created using the various screens shown in FIGS. 6-14;

FIG. 16 is a further representative illustration of a screen confirming a completed order, assigning an order number and providing an approximate time for order delivery in minutes to a user placing an order by swiping a credit card after instructions to do so in FIG. 15; and

FIG. 17 is a further representative illustration of an exit screen for canceling an order without paying after viewing a calculation total such as that shown in FIG. 15.

### DETAILED DESCRIPTION OF THE INVENTION

As used herein, words such as “upper” and “lower”, “interior” and “exterior” and words of similar import are used with respect to directions in the drawings for convenience in understanding the invention with reference to the drawings and should not be considered to be limiting.

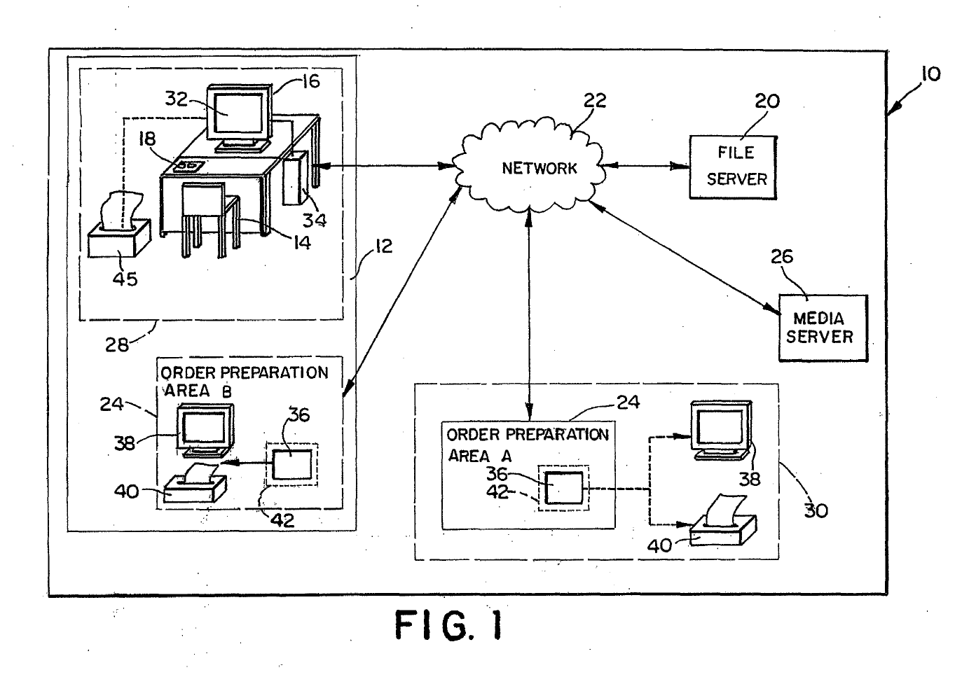

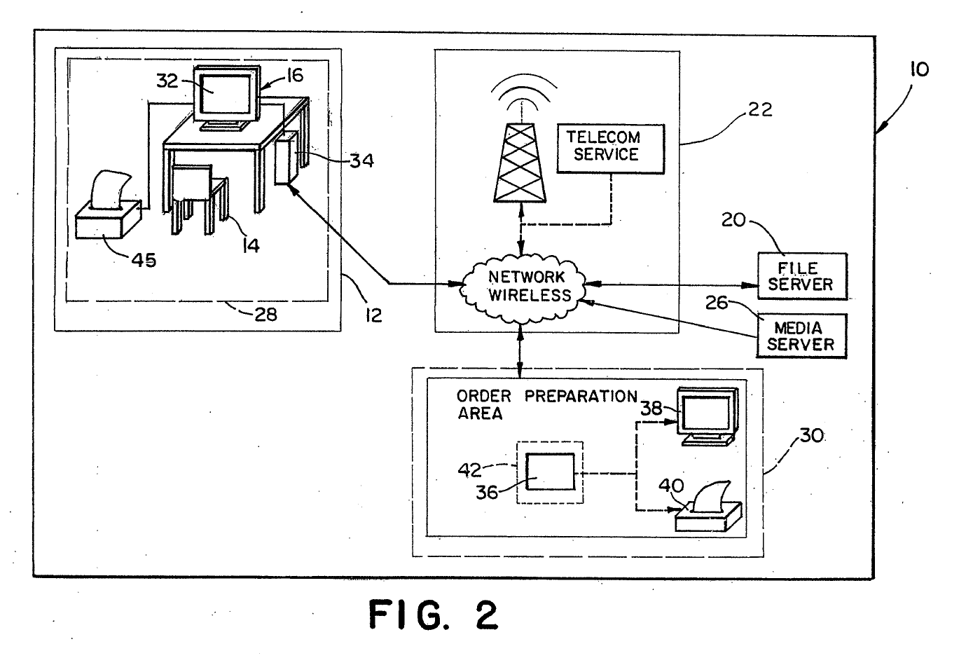

The invention is directed to a system for ordering items from an area within a limited venue for delivery to that area, a method for ordering such items in such a venue and more specifically to a new design for an airport gate hold area. The system is first illustrated by a schematic diagram as shown in FIG. 1 and in FIG. 2, which includes a wireless embodiment according to an alternative embodiment as described herein. An embodiment of the system is shown in FIG. 1, which includes a system, generally referred to herein by reference number 10, having a limited venue 12 having at least one seat 14 and at least one kiosk 16. A power outlet 18 is also provided. The kiosk 16 is in communication with a transaction server 20 via a network 22, which server 20 is also in communication via the network 22 with an order preparation area 24. The network 22 also preferably includes a media server 26. A seat or seats 14 as described further herein are preferably located within a reasonable proximity and/or adjacent to the kiosk 16 as is the power outlet. As used herein a “kiosk” may be a traditional kiosk, such as those used at movie theatres for ticket ordering and/or printing and in airport baggage handling areas for ordering and/or printing boarding passes and checking luggage, or a kiosk, more preferably is in a format of a separate computer, touch screen and wiring that is built within a total seating area as a detachable or integral feature, as described further herein below. However, it will be understood based on this disclosure that while such a kiosk as described above is preferred, a kiosk within the scope of the invention should have a computer-based user interface and be capable through interaction at such interface (such as via a touch screen, mouse-activated screen selection, voice-, phone- or cell-phone activated interaction), of transmitting orders and receiving ordering related information so as to be useful in the methods described herein while being accessible to users in a limited venue as described herein.

A limited venue 12 may be any area where people are waiting and/or seated for periods of time and in which it would be desirable to have items delivered to the area to avoid inconvenience and/or where leaving the area is typically not practical, for example, a bus depot waiting area, a train station waiting area located near the boarding gate, a gate hold area of an airport after passing through security, a doctor or hospital waiting room area and the like. In one most preferred embodiment, a gate hold area is the limited venue 12 within a system 10 for purposes of illustrating the invention, wherein due to security issues and other limitations such as potentially missing a flight, one cannot leave the gate hold area readily and ordering choices in that area may be limited or not easily accessible.

A kiosk is preferably placed within an area 28 of the limited venue 12 convenient for use and ordering of items, however, it may also be located in an area 30 outside the limited venue for ordering prior to entering the limited venue 12 and/or placed both within and outside of the limited venue 12. In a preferred embodiment, there are multiple kiosks 16 each of which is located within the area 28 of the limited venue 12.

Each kiosk 16 preferably has a touch screen 32 and is also preferably adjacent a seat or seat(s) 14 so that users may be seated while selecting and transmitting menu items offered on the touch screen 32 to the server 20. Touch screens may be of varying sizes, from small screens to larger user screens; however, it is preferred for purposes of a preferred embodiment of the invention, that the touch screens are a standard 14.1 inch touch screen. For order delivery to be expeditious and directed to the area 28 within the limited venue 12 near to the ordering kiosk 16, each kiosk 16 will preferably have an identifier of some sort, for example, a location identification reference number or sequence that is transmitted along with each order.

Each kiosk 16 also preferably includes a computer 34 capable of running an operating system, e.g., a Windows® XP operating system or any other base operating system. In addition, it is preferred that software capable of delivering an order from customer input to a server is loaded on the computer. A preferred but non-limiting example of such software is NEXTEP SYSTEMS® Self Service software, which delivers a customer user interface and experiencing. Suitable software and ordering methods are described in U.S. Publication No. 2007/0265935 A1, which is incorporated by reference herein with respect to the descriptions of various ordering systems and features. It will be understood based on this disclosure, however, that other suitable operating systems and software packages may be used (available now commercially or to be developed and/or written for this purpose) if they are capable of carrying out the steps and functions set forth herein. The software is preferably modified and/or programmed so as to provide the items to be offered for ordering and other desired ordering information, pricing and the like, as well as to include the kiosk identifier. The items to be included are preferably those items that are available for delivery from a designated order preparation area 24.

A completed order placed at a kiosk 16 is transmitted to a transaction server 20 via a network 22. The transaction (file) server 20 functions as a main database for all operations within the system 10, and is preferably an Intel®-based transaction server driving a suitable server operating system, preferably Microsoft® Server 2003 Operating System. It should be understood, however, that other types of transaction servers working on other operating systems, capable of carrying out the functions herein are within the scope of the invention whether available now commercially or otherwise, or to be developed. When a completed order is submitted by a user, the transaction server 20 forwards an estimated time for delivery to the kiosk 16 of the ordered items for review by a user. The estimated time is based on the longest preparation time in the system 10 for any of the specific items ordered. For example, if several hamburgers are ordered and one is a “well done” hamburger having a preparation time of 20 minutes, which has the longest preparation time in comparison with preparation times for all items ordered, the user U will be notified that the order preparation time is 20 minutes.

The network 22 preferably includes a media server 26 that can store and forward advertisement(s) and/or other information to the kiosk 16 for continuous, updated and/or real-time review by a user. For example, if the venue 12 is a gate hold area, the media server 26 can provide designated advertisements or advertisement feed from a network source, real-time flight information, gate information, weather forecasts, news information, event schedules.

Alternatively, the media server 26 can be coordinated with the airport flight time computer server such that flight times can be fed to the media server 26 and then to the kiosks. The transaction server software, such as NEXTEP SYSTEMS® software can be further modified to include a step to prompt the user after the order time is displayed to also display current flight information so that the user can decide whether to proceed with the order and/or whether to order more or different items. For example, after order time is displayed, the screen can prompt the user by asking whether the user would like to access specific flight information. If the user elects to do so, the user can either enter his or her flight number or use/swipe a credit card that is coordinated with the airport flight information (such as when ordering e-tickets and boarding passes). After the flight information is entered, the kiosk communicates with the transaction server and/or media server 26, which is coordinated with the airport terminal information to provide an update on flight time to the user. When the flight information is displayed, the kiosk can prompt the user to either proceed/continue with the order and/or edit the order. Thus, the user has the ability to abort the order if the preparation time is more than the allotted time before the relevant flight. Alternatively, if a flight has been delayed, the user may want to order more items, further beverages and the like.

If the venue 12 is a hospital waiting area, the media server 26 can provide hospital information, hospital maps, news broadcasts, health information, emergency call information, first aid information and the like. It is also within the scope of the invention to allow users to pay hospital co-pays and other outstanding accounts by accessing personal information in the hospital's billing system through a credit card or other identifying criteria if the media server 26 is coordinated to the hospital's electronic billing system.

The media server 26 can receive information thereon directly from feed at the venue 12, e.g., venue events, weather, and flight information, etc. Such information can be provided in a separate information area of the screen and/or through a continuous feed area on the touch screen of the kiosk 16, e.g. scrolling on the bottom of the touch screen 32. Information can also be provided by an outside network source or preloaded information such as pre-programmed advertisements.

The network 22 allows for all electronic and data communication between the kiosk 16, the transaction server 20, the media server 26 and the various printers and order stations within the order preparation area 24. The network 22 may be of a hard-wired configuration, for example, wherein the network includes unshielded, twisted pair copper cabling extending from end nodes, such as at the kiosk 16, to the nearest wiring closet. Wiring closets (not shown) are known in the art, and can be used for connection via multi-mode fiber optic cables. Further, as illustrated in FIG. 2, it is recognized by one skilled in the art that a wireless network could also be used with the scope of the invention. These networks could be either a local/specific wireless data communication network or a public wireless telecommunication and Internet-based infrastructure. These systems are well known in the art and discussed in U.S. Pat. No. 6,920,431, incorporated herein in relevant part with respect to description of such a network.

A variation on the system 10 design allows for ordering from various locations to coincide with an activity of a venue. For example, if the venue 12 is a gate hold area, a user can order at a fixed kiosk 16 using network 22 and/or link to the kiosk 16 and/or transaction server 20 directly from a remote location via a wireless network 22 through an Internet interface and continue waiting for a flight while working and/or monitoring flight information, until the order is prepared based on the preparation time. Such remote location ordering can include ordering via a separate Internet computer (such as a traveling user's laptop), a cell phone and/or a PDA. When using remote ordering, the Internet interface should provide guidance as to entering the location or other identifier of the closest kiosk 16. Such ordering helps minimize lines and waiting at kiosks if a particular order area 28 near a kiosk 16 is crowded. In other venues, such as a train station gate area or bus depot waiting area, ordering may also take place via hard wired or wireless/Internet based networks 22 as noted above, and the kiosk 16 may further be wired to a network 22 located in a venue such as a gate hold area so that the user can take advantage of the seating 14 and/or outlet 18, e.g. for comfort and for use of personal electronic devices.

The order preparation area 24, which receives information input into particular kiosks 16 through server 20, includes at least one display device 36, which displays the orders received via the network 20. The display devices 36 can include a display screen(s) 38 and/or a standard ink printer(s) 40, e.g., an Epson® TMT 88 thermal printer or a conventional visual display monitor such as those used in drive-through or other restaurant ordering areas.

Within an order preparation area 24 there may be various individual preparation areas 42 or a larger centralized order preparation area. The order preparation area 24 is used to prepare specific orders of items based on the description provided from the kiosk. Items for order may include, e.g., hot food, cold food, beverages, books, newsstand items, souvenirs, sundries, travel items, toys and other items typically requested in a limited venue such as the limited venues noted herein. The transaction server 20 directs an order to the display devices 36 at the appropriate location, such as the more specific locations 42 within the order preparation area 24 based on the ordered items. For example, if the order preparation area has a common area for order preparation, then only one area need receive the order information which can appear on a common or multiple display screens 38 or come in for view from a print-out via a printer(s) 40 or both. However, if the order preparation area 24 includes several preparation locations 42 for varying types of items, such as for example, different kitchens in a food court area, then display screens 38 and/or printers 40 may be located in each preparation location 42 which collectively make up the order preparation area 24. For example, when the order preparation area is a stock room common for many related stores, it can be a single location, or it can be the order preparation area within each of several stores in a general shopping area. Once the order is received, it can be simply displayed on a screen for review by those preparing the order or printed out on a printer. In a further example, the order preparation area may be a common kitchen providing food to various locations in a food court area or a collection of individual areas each corresponding to an independent restaurant or food service location.

The order preparation area and/or restaurants, shops, etc. fulfilling the orders may be within the limited venue 12 and/or located outside that area but within a reasonable distance for delivery as described herein. One of the advantages of the system 10 is that even if there are limited options for obtaining food and other items within the limited venue 12, the kiosk ordering option allows for delivery from outside the limited venue into the limited venue or from a farther location within the limited venue without the user having to leave the designated waiting area, potentially leaving other people, bags, electronic devices and the like unattended or in the care of others (or having to keep such items with the user when they leave to go obtain food and other items). Further, and especially beneficial in an airport where the venue 12 is a gate hold area, the user does not have to go back through security to obtain food or other items from areas outside the secure gate hold area or does not have to worry about moving baggage, children, to obtain items, or give up a coveted outlet location for use in conducting business through an electronic device to obtain items or coveted seat location in a crowded waiting area.

The order, once prepared can be “picked-up” at the location of the preparation area 24 by users for “self-delivery,” or more preferably, a delivery system is put into place which brings the order to the user located in the limited venue 12, and more preferably at an area 28 located near the kiosk 16 from which the order was placed. For example, a delivery system may include one or more delivery persons who physically walk to the venue 12 with the order for delivery and/or who drive via carts and/or personal conveyances (roller skates, skateboards, scooters, trams, travel vehicles, cars, trains, Segway® and the like) to the area or can include a conveyor or other automated system built into the area for delivery which is accessible to users and/or personnel working in the area so as to avoid delivery personnel having to enter certain limited venues wherein for security or other reasons may have limited entry in the area prohibiting delivery personnel. The delivery system can also take advantage of an existing delivery system for mail or other items. A separate hallway system (with pre-approved security access for workers) allowing delivery personnel to pass in and out of a final secure area (such as a gate hold area) without having to continue to go through security—perhaps having a clearance pass that allows entry and egress is also contemplated. The delivery system delivers the order items to a user in the venue 12, preferably to the area 28 near the kiosk 16 from which the order was made taking advantage of the identifier of the kiosk 16 to locate the recipient.

Payment for the order is preferably through an automated system, but can also be accomplished through a direct transaction. Payment can be via cash, credit card, debit card, pre-paid travel or gift card, coupon, etc. at the time of ordering, pickup or delivery, depending upon preference. As a result, a preferred optional feature of the system is a magnetic swipe reader, such as a 2- or 3-track magnetic swipe reader, for reading credit cards, debit cards, gift cards or perhaps frequent buyer, membership and/or rewards cards. Thus it is within the scope of the invention that frequent users of the system 10 within a repeat limited venue 12 could take advantage of airline or other sponsor membership rewards programs providing points and/or discounts towards future purchases or off of purchase of other goods within the programs. Such programs are well known in the art for use in supermarkets, food courts, food chains, shopping stores and areas, and the like. It is most preferred that payment occur upon order with an option to add a tip for the delivery person(s) in the order total through credit card or debit card to eliminate the need for travelers or those in such venues to rely on cash that may be needed for traveling and/or that can cause safety or security issues. However, cash-based purchases are within the scope of the invention.

When an order is placed, for the convenience of users, a kiosk 16 in the system 10 may also include a printer 45 for printing a payment receipt and order identification data. The printer may be a printer such as that used in the order preparation area 24, for example, an Epson® TMT 88 thermal printer. It is also within the scope of the invention that orders placed can be confirmed with order information via email, SMS, text messaging and the like if the correct information is provided to the ordering system and such options are incorporated in the ordering system.

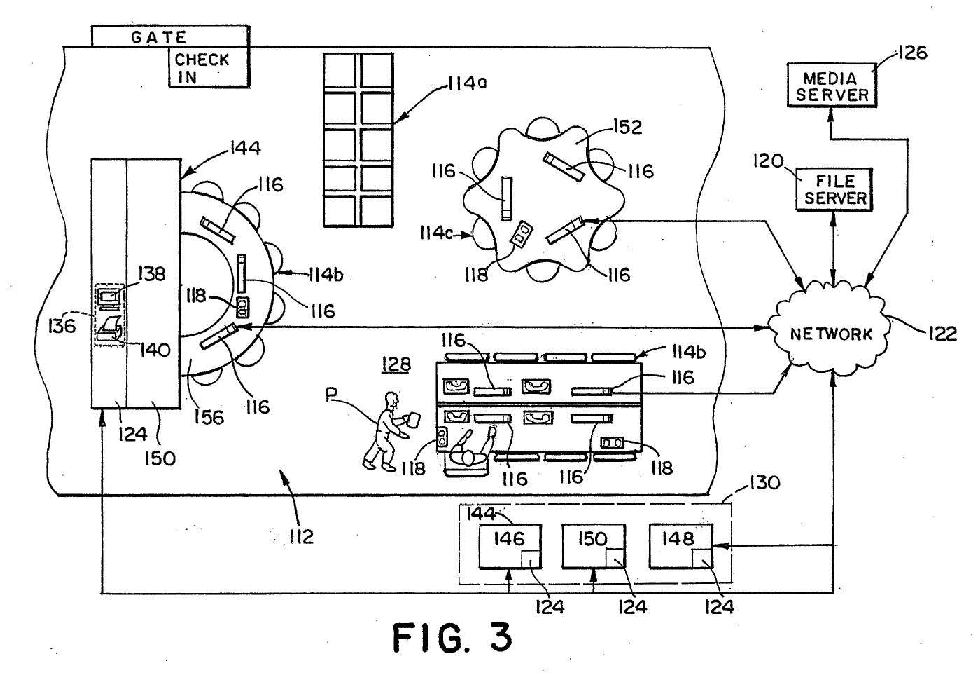

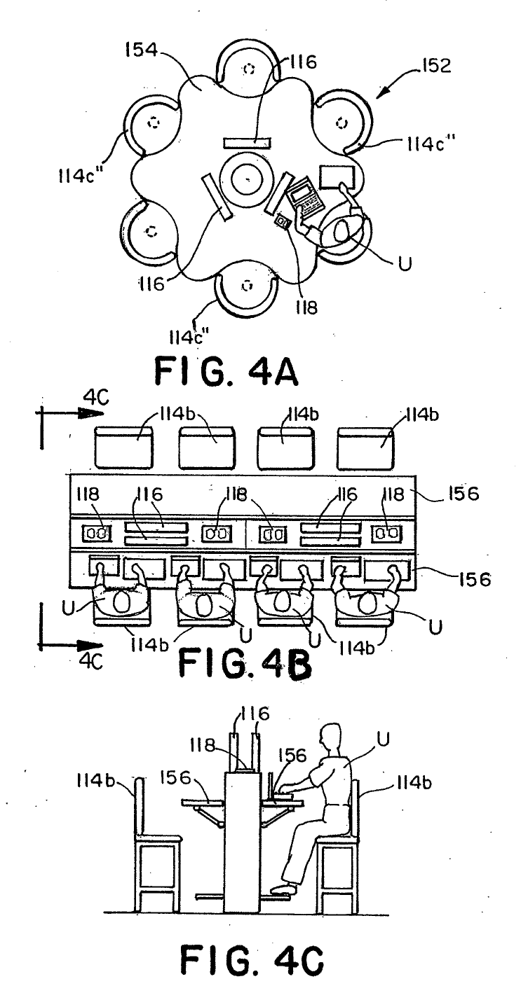

Also within the invention, as shown with reference to FIGS. 3, 4A, 4B and 4C, is an airport gate hold area 112 including a lounge for ordering items by users, who are travelers and/or those accompanying travelers, in a gate hold area. The gate hold area, designated 112, in FIG. 3 is for receiving delivery at a designated location such as location 128 within the gate hold area in an airport via kiosks 116 placed in the designated locations 128. This gate hold area 112 includes seating 114, at least one kiosk 116 in a designated ordering location 128. The area 112 preferably has at least one power outlet 118 within the gate hold area 112, preferably located near or within the kiosk 116. Additionally, at least one vendor location 144 is provided within the gate hold area, for example, a store offering items for order, such as an express market 146, a bar 148, and a restaurant 150. Menu items available at the vendors located within the gate hold area 112 can be accessed via direct point-of-purchase sale according to standard food purchasing options or can be ordered for delivery or pickup using the kiosks 116.

The gate hold area 112 may include various types of seating 114. It may include traditional gate hold area seating, which typically includes seats in rows, which may be connected and/or arranged back-to-back 114a. In addition, it may include seats at one or more of the vendor areas, such as bar-type seating at a bar or counter service restaurant seating 114b, or similar high-seating having tables for seated dining or working 114b, and seating 114c associated with pods 152. Any of the types of seating may also be equipped with kiosks 116. The unique pod 152 and/or other seating having kiosks 116 can accommodate single patrons (such as a single seated ordering kiosk), a group of patrons (for common usage by one or more users who may or may not be associated with one another as in a family or work group) and the like. Specifically, as illustrated in FIG. 4A, seating 114c″ similar to 114c in FIG. 3 with padded backing in a pod 152 includes a pod table 154 having at least one, and preferably multiple kiosks 116 and having at least one, and preferably multiple power outlets 118 so as to allow group members to work together or individuals to work separately, but in a group setting. In FIG. 4B, an example of a top view of a high table or counter type seating 114b is illustrated having a table and/or counter height surface 156 wherein each user position is preferably equipped with a power outlet 118 and/or easy access to a kiosk 116. As in FIG. 4C, a side view of such service station is shown. A family or other affiliated group can also use a multi-seat table 114b in a more rectangular configuration for eating, working or other activities. Such table seating 114b also preferably includes at least one power outlet 118 and at least one kiosk 116.

Most preferably, each of the various types of seating arrangements 114b, 114b″ and 114c with the exception of more traditional seating 114a, has an accessible kiosk 116 and power outlet 118 for each two-patron location. For example, for a table 114b having eight seats there are preferably four kiosks, each located between two adjacent seats for access by two users. However, it is within the scope of the invention to have a one-to-one kiosk to seat ratio or fewer kiosks per seat. It should be understood based on this disclosure that the type of seats, the types of table designs and the kiosk-to-seat ratio may be varied within the scope of the invention.

Further, it is preferred that a gate hold area or room 112 has have multiple types of seating arrangements within the same area as shown in FIG. 3. These seating configurations are intended to be exemplary only and not limiting, and it should be recognized based on this disclosure that other table/seating configurations having a seat, a kiosk and preferably at least one outlet are within the spirit of the invention.

The kiosks 116 in the gate hold area or room 112 are preferably the same as those described above with respect to system 10 having kiosks 16. Such kiosks 116 are preferably in communication with a server 120 via a network 122, wherein the server 120 is also in communication with at least one display device 136 that may include a display screen 138 and/or a printer 140 within an order preparation area 124. The order preparation area 124 may be inside or outside the gate hold room, however, the kiosks 116 should be in communication therewith. An optional media server 126 may also be provided in communication with the kiosks in the gate hold room which is capable of providing information, such as that noted above with respect to media server 26 in system 10.

The kiosk 116 preferably includes an interface in the form of a mounted touch screen located on the seating configuration adjacent one or more seats 114b, 114c, 114b″, but can also take other forms such as “push-button” ordering through a keypad, a wired or remote mouse for input to a screen, a voice activated system, or an Internet-based system in which a screen displays the ordering items and orders are placed through a remote and/or wireless input into an Internet page designated for ordering. Preferably, the kiosk 116 includes a touch screen. This kiosk 116 is capable of allowing for selection of items to be ordered for transmitting the order information to a server 120, which may be the same as server 20 described above in system 10. The orders from the kiosk 116 transmitted to the server 120 are then transmitted to an order preparation area 124 (which may be the same as order area 24 in system 10) for preparing the order. Completed orders may be delivered to the gate hold area 112, preferably to an area 128 near, adjacent to or containing a kiosk 116 as discussed above.

As illustrated in FIG. 3, the preparation area 124 can prepare orders including items from restaurants, shops, etc. located in an airport concourse, or which are within the gate hold area. Orders are available for items within a reasonable delivery distance and for competing items from different sources, orders are preferably filled with priority sources offered as those which are in the closest proximity to the hold area 112, and more preferably in the closest proximity to the area or location 128 having the kiosk 116 from which the order is being placed.

The kiosk 116 will preferably include an automated payment system such as that noted above which may include, for example, a coin acceptor, a currency acceptor, a credit/debit/EBT card acceptor, and/or a coupon acceptor as well as the ability to read discount cards, membership cards, gift cards, reward cards and/or frequent buyer cards. A magnetic strip reader is preferably included as an optional feature on the kiosk for authentication and authorization of the various cards that can be used for payment. For the convenience of users, a kiosk 116, as with kiosks 16 in system 10, may also include a printer for printing a payment receipt and order identification data and/or the ability to obtain a text, email or SMS message confirmation of an order in lieu of or in addition to a printed receipt. The kiosk software is preferably capable of generating sales and revenue data, order tracking and preferences, and other accounting information based on the items selected. Tracking such data can enable changes to be made to the list of available items, such as the foods available at the kiosks from surrounding restaurants based on the overall preferences and/or help to develop a “theme” of preferred items to be available for a designated gate hold area 112 and/or kiosk location 128 based on sales, thereby keeping the item selections new and most-appealing to users. Automated payment, such as a magnetic strip card reader, is also preferred in that it allows for expedited service so as exclude the necessity of waiting for a receipt or currency change, and provides a level of security to travelers.

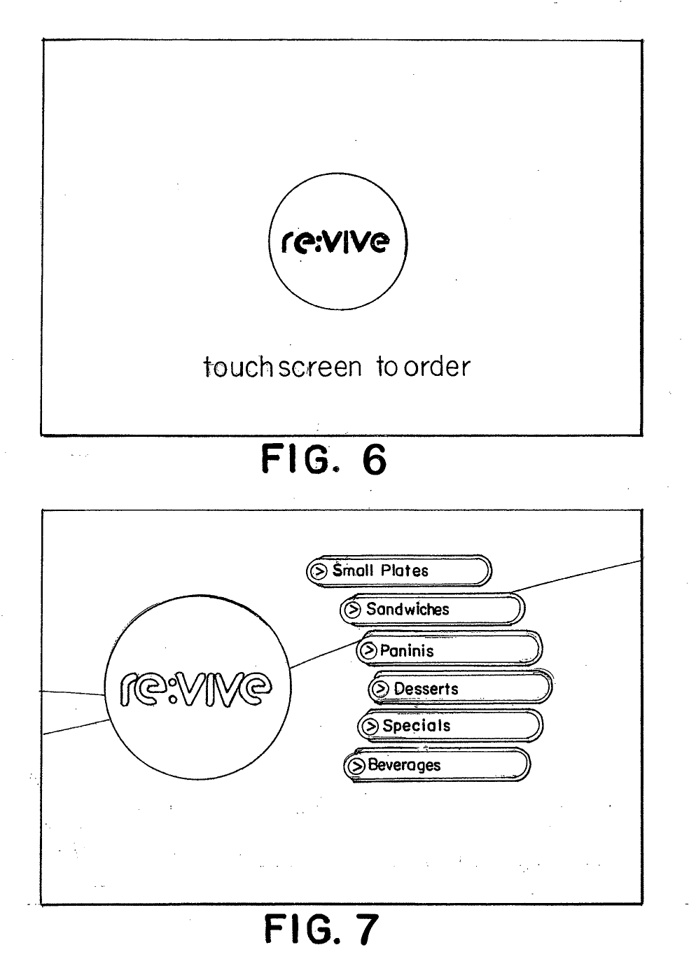

As in the system 10, the kiosk 116 in the gate hold area 112 should have a computer 134 that runs on an operating systems, e.g., Windows® XP operating system, having a self-service software, e.g., NEXTEP® Self Service software, which delivers a customer user interface. The software interface of the kiosk 116 may take the form and have a display as illustrated in FIGS. 6-17.

The completed order placed at the kiosk 116 is transmitted via a network 122 to a transaction server 120. The transaction server 120 can be as described with respect to transaction (file) server 20 in system 10 described above. The transaction server 120 preferably has the ability to transmit estimated preparation time for an order via the network 122 to the user through the kiosk 116 interface based on the item having the longest preparation time in the order. In addition, through the media server 126, flight information, weather forecasts and the like may also be delivered to the user which can be also valuable to the user in terms of determining whether the estimated order preparation time is adequate. Additionally, the kiosk and/or media server 126 software can also be adapted to coordinate flight information while the user is ordering and evaluating the order so as to coordinate the delivery time with a flight arrival or departure time as described above. For example, while a large order with a long delivery time may not be acceptable to process to a user when a flight is about to depart, so that the order may be rejected by the user prior to paying for the order, the same order may be acceptable to the order if a flight is delayed.

The media server 126 is preferably able to store and forward advertisements and other information that may be useful in a gate hold area, e.g. flight information. Such information may be transmitted to the kiosk 116 for continuous and/or real-time review by a user as described above with respect to media server 24 in system 10. The kiosk 116 may be configured so as to have a designated button section to allow for instantaneous acquisition of particular information on demand if not otherwise displayed, e.g. a specific flight departure time or time of day.

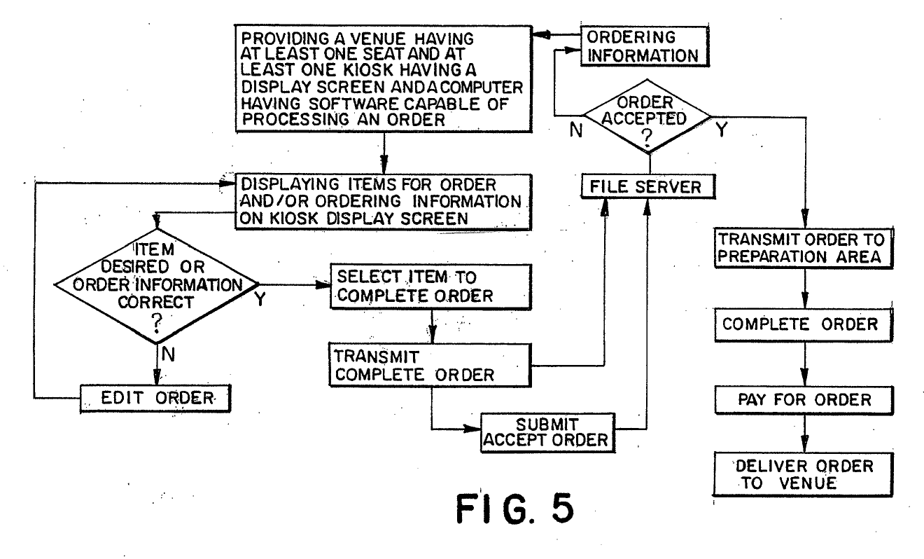

Referring to FIGS. 3 and 5, an order preparation area 124 is designated for a particular gate hold area 112 (or can serve more than one and/or a group of gate hold areas). The distribution of the orders to the preparation area 124 would operate the same as discussed above with respect to server 10 and preparation area 24. A kiosk 116 may include within its item offerings items available in preparation area 124. It is recognized that alternating menu items available at a particular kiosk 116 in a particular kiosk location 128 can be achieved by minor adjustments to the kiosk software and/or by the software weighting frequent orders by preference to offer first and most prominently those items most frequently requested and/or which have the easiest ordering speed and convenience and/or which are placed with the vendor(s) in the closest proximity. The order of items on screen may be static or dynamic in the latter instance using various ordering criteria and even allowing for customers to have repeat selections or most recent orders recalled and/or recognized from within the system transaction server in accordance with ordering software known in the art, such as NEXTEP SYSTEMS® software. It is also within the scope of the invention to allow for a frequent traveler to have preferred order preferences associated with a user card so as to call up on a kiosk 116 frequent user order choices for expedited ordering.

By allowing for the satisfaction of orders from vendor(s) both inside and outside the gate hold area, the gate hold room kiosk 116 in communication the server 120 is able to offer a traveler/user in the gate hold room access to food or other item delivery from an area normally not readily accessible to the traveler without leaving the gate hold room 112 and without having to leave and pass through security. Otherwise, frequent travelers using the same gate on a routine basis have only limited selections from which to choose from for food, reading, gift purchases and the like. Within a long “hallway” design of an airport concourse, several available preparation areas 124 may be made available to provide items for delivery to a specific kiosk 116 and kiosk location 128. For example, as best illustrated in FIG. 3, the design of the concourse can allow various restaurants 150, bars 148 and/or stores 146 to be accessible wherein each such store, bar or restaurant has its own designated preparation area 124 having its own display devices 136 as discussed herein. Alternatively, several restaurants 150 or the like may share a common preparation area 124.

The software included at each kiosk 116 in different gate hold areas 112 may vary so as to reflect items available from stores 146, bars 148 and/or restaurants 150 located so as to fulfill an order within a particular reasonably programmed period of time, and/or which are located within a specific distance parameter. When the vendors change after a specified period of time, e.g. 6 months, the software in the kiosks nearby may be modified so as to reflect the available items after the change. Thus, a user who must use a specific gate in the proximity of a particular hold area may not have the same items always available for express order, but may still have the ability to access orders from other gate hold area locations, concourse locations and the like.

After completion of an order by an appropriate preparation area(s) 124, a food transport and/or delivery system such as a delivery person P may deliver the order to the user U located in a gate hold area 112 in an area 128 near and/or including the kiosk 116 from which the order was placed.

If the display device 136 in the preparation area 124 includes a printer 140, the order may also print out with a UPC barcode representative of the order. A barcode reader may then be used to scan the barcode when the delivery person P departs from the preparation area 124 to take the order to the user and/or upon return from delivery of the order to the user in order to track delivery time and completion. This can feedback an up-to-date order status through the server 120 to the kiosk 116 so that the user can track status updates on an order much in the same way a system used by an overnight courier, such as Federal Express or UPS can track orders using such scanners. Such systems are well known in the art and commercially available for optional attachment and integration to the system 10 and/or to the kiosk 116 in gate hold area 112 and so are not described further herein. However, it is preferred that such order tracking and confirmation be done electronically without the need for UPC devices and paper use, but electronic order tracking and/or credit card identification.

Accessibility of the hold area 112 from the preparation area 124 could be via a central walkway within the concourse and/or through a corridor(s) arranged to pass from a preparation area(s) 124 to the gate hold area strictly for delivery, wherein the corridors would not be accessible to the public thereby reducing congestion for delivery and allowing for security surveillance and/or protection of delivery personnel in areas post security checkpoints requiring special user identifications and security clearance.

In one alternative embodiment, the invention includes a method for a user to order items for using a kiosk for delivery to a limited venue and more preferably to an area within the limited venue near to or including an ordering kiosk. As shown in the flow chart of FIG. 5, the method includes providing a limited venue having at least one kiosk therein. The limited venue and kiosks may be any of those described herein. The venue provided should also include at least one seat and preferably also includes at least one power outlet also as described herein.

The method further includes selecting an item from a selection of items using the kiosk, and completing an order by transmitting the order to an order preparation area via a server on a network. Thereafter the method includes preparing the order and delivering the order to the limited venue, preferably in an area adjacent to or including the kiosk, to a user who places the order. The selection of items can be determined as set forth above using the kiosk software and various preferred parameters (closeness of a vendor, user preferences, changes in available items). The order can be transmitted via a display screen such as a touch screen on the kiosk, via a network to a server as are described elsewhere hereinabove. A user entering a gate hold area such as 112 or other limited venue 12 can locate an ordering kiosk 16, 116 having an interface, such as a touch screen through which to order menu items as shown. The order can have an introductory screen to initiate ordering and a series of broader menu categories, for example as shown in FIGS. 6 and 7. The kiosk 116, prior to activation by the user, will display a welcome screen (FIG. 6) and then a number of various categories of items for choice by the user as in FIG. 7. Further, the kiosk 116 may have a rolling ticker or part of the screen (not shown) that updates the user with other relevant venue information, such as for example, flight status, intermittent advertisements and weather forecasts when the venue is a gate hold area of an airport. Thus, the method may further, optionally include providing additional information to a user through a media server in communication with the kiosk through the network.

A user initiates the specific ordering steps by pressing or otherwise indicating or selecting one of various general categories of available choices on touch screen 32 of the kiosk as are shown in FIG. 7. In one embodiment, initiation of the ordering process can optionally produce an Avatar, e.g., a personalized concierge, which greets the user, and helps lead the user through the ordering process, including understanding the available choices for selection, and instructs the user on the various options, pricing, available order time, confirmation of the order and/or payment for the order. After a “greeting” from the personalized concierge, a menu of choices is presented to the user, e.g., gift shop items, entrees, appetizers, beverages etc., which choices are preferably customized to the specific kiosk in a particular limited venue, such as a particular gate hold area, based on the available vendors, such as restaurants, bars and stores, which may work in cooperation with a single order preparation area, may each have their own preparation area, and/or some of which may have a pooled order preparation area. Thus, it is recognized that the interface such as the touch screen 32, 132 of a kiosk 16, 116 preferably has audio as well as visual components for ease of use for a user and for ensuring better accuracy in ordering, although use of simple visual components is also within the scope of the invention.

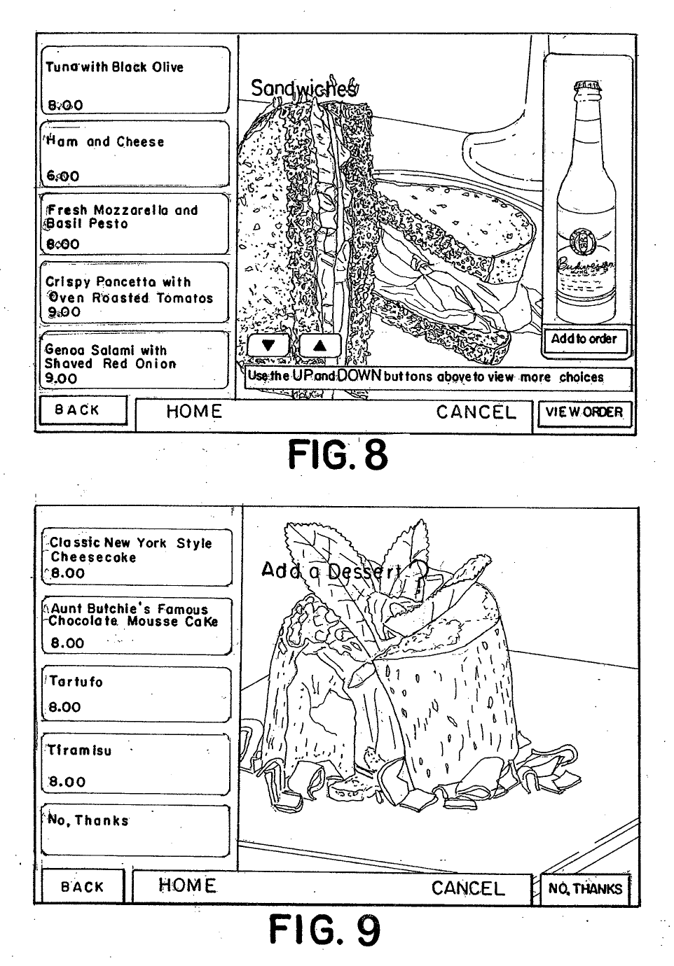

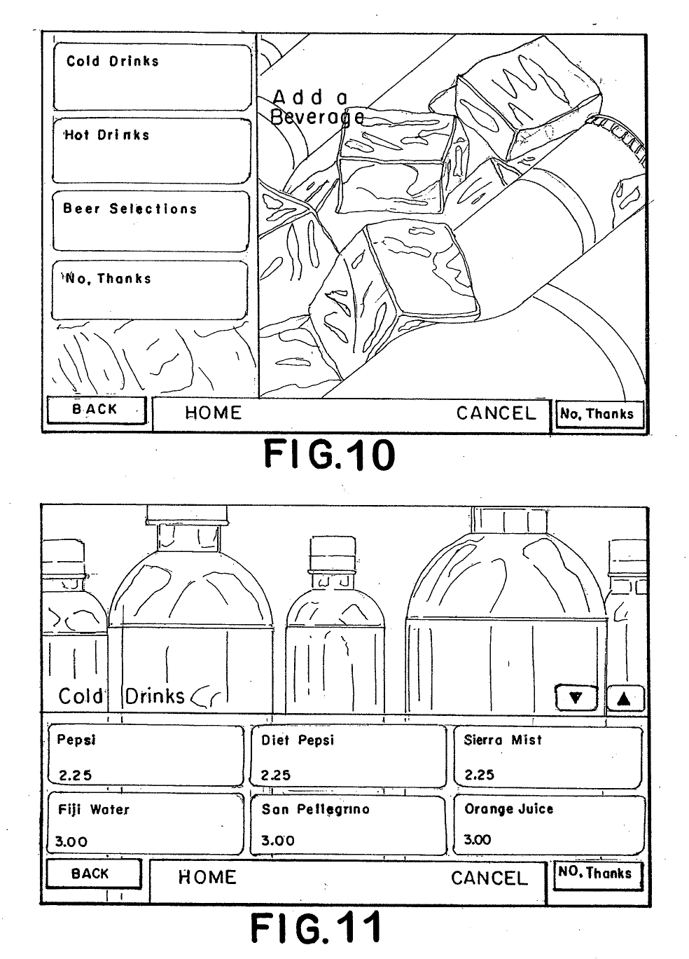

The user preferably touches the screen 32, 132 thereby selecting an item, such as the item shown in FIG. 8, wherein the category of “sandwiches” is chosen from the general menu in FIG. 7. Then the particular sandwich chosen from FIG. 8 is transmitted to a transaction server 20, 120 via a network 22, 122. If the item requires special instructions, i.e., gift-wrapping, additional toppings or cooking temperatures for foods, the screen can identify the options available for the user to select. Further, “additional information” regarding an item selected can be presented by an Avatar if an Avatar is used, e.g., the personalized concierge (or other pop-up message or button option) may warn the user of a required long preparation time. Similarly, as shown in FIG. 9, if the “dessert” category is selected from FIG. 7, further dessert options can be selected (or “no thanks” chosen) which information is also forwarded to the server. FIG. 10 shows selection of beverages if the “beverage” category is selected from FIG. 7. If a particular category is too broad for specific choices as shown in FIG. 10, further sub-category menus like that shown in FIG. 11 can be used as well. For example, if one selects “cold drinks” from FIG. 10, a further cold-drink menu appears as in FIG. 11 for additional options/selections.

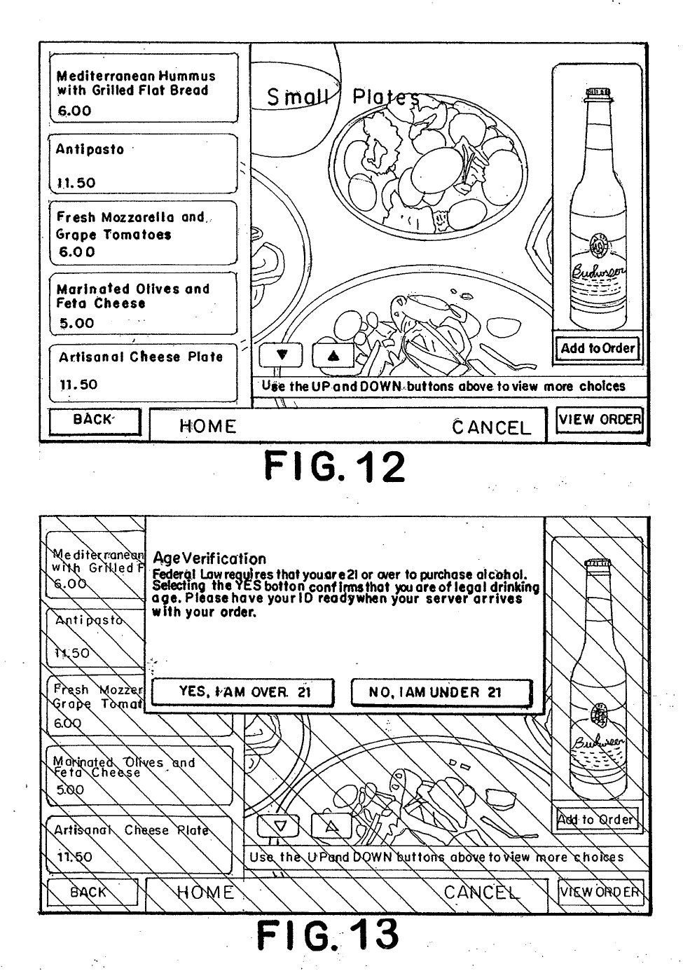

FIG. 12 demonstrates an embodiment, wherein a category, such as “small plates” is chosen from FIG. 7, and the screen itself allows viewing (using up and down buttons) of various choices available and also provides an option of adding a drink to the order. In the case of the example in FIG. 12, the drink option is alcoholic. If the item selected contains alcohol, it is possible to provide a warning. For example, the screen will darken (shown by cross-hatched lines in the illustration but in appearance the background could darken to highlight the message) and a highlighted message/warning could appear so as to advise the user of the legal drinking age and note that proof of age will be required upon delivery of the order. Any additional information displayed to the user may require a confirmation before inclusion with the order. After selection of various items from the menu, the user is given an option to add an additional item or to signify that the order is complete (view order). Further, at any time during the ordering step, the user can select an option, such as an on-screen “button” to review the entire order and make any desired changes prior to finalizing the order.

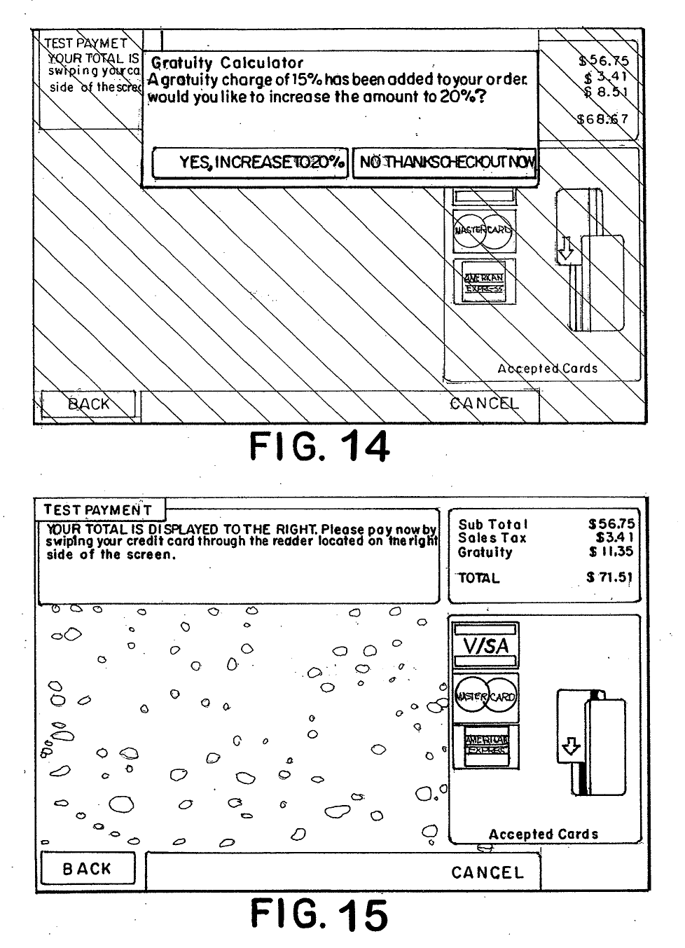

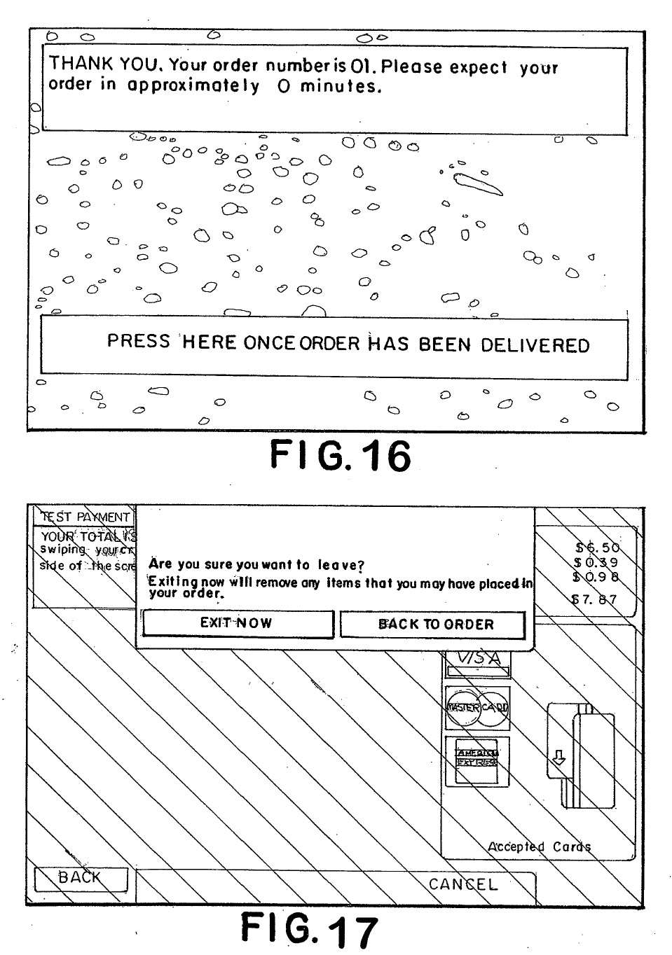

When the order is complete, the user selects whatever button indicates “order complete” option (which, for example, could be made available in a screen allowing the user to view the entire order), and transmits the completed order to a transaction server 20, 120. The items are received, reviewed by the server, which then transmits the estimated preparation time calculated by the transaction server 20, 120 back to the kiosk for the user to consider. The user then is provided with a payment totaling screen, and is preferably also given the option to calculate a gratuity as shown in FIG. 14. As with the alcohol confirmation warning, such an option box can appear brighter, with the total calculation screen dimmer behind it to highlight the option of the gratuity to the user, but that feature is optional. If the user selects a gratuity, that would be added into the total along with applicable tax or other charges levied by the system, airport, venue, etc. Once the total is calculated, as shown in FIG. 15, the user has the option to cancel the order and leave the system (for example, the order is wrong, needs to be changed or the user determines not enough time is available) in which case an “exit now” prompt is activated. Similarly, a time screen confirming the order can appear before or after paying (depending on how the system is set up) to warn to use of available time prior to delivery to give the option of exiting to the user and/or if the user is committed to the order and has paid to know when to expect the order to arrive. Such an optional time and order confirmation screen (with order number) is shown in FIG. 16.

When the user receives the estimated preparation time for the completed order and the total cost transmitted from the transaction server 20, 120, the user preferably is also able to receive any real-time venue information transmitted from the media server 26, 126 to the kiosk 16, 116 via the network. For example, while reviewing the order delivery time on the kiosk screen as transmitted back to the user from the server, the user can also be reviewing the flight time schedule. Specifically, the complete order is presented with quantities of each item ordered, prices, etc., and the user is given the option of accepting the order to finalize it, declining the order in view of one or more factors (such as perhaps flight time changes or cost), or changing the order. If the user declines the order, the kiosk 16, 116 returns to its initial screen options. If the user changes the order, the order is then completed again, transmitted to the transaction server which transmits back an updated estimated order time, and the user then must decide whether to accept, decline or modify, wherein the process repeats until the completed order is accepted by the user. If the user accepts the order upon reviewing the estimated delivery time, the user is prompted to finalize the order and also preferably prompted as to whether the user wants to include in the total a gratuity for delivery. There are many variations that can be provided in this regard and options for the user, and the above is intended as an illustration of a sample preferred ordering system, and is not intended to be limiting.

In the method, after transmitting the completed order to the server, and receiving the estimated delivery time, the user accepts the order having an appreciation for the preparation time and all relevant venue information, such as available transportation information received from the transaction server 20, 120 and the media server 26, 126.

The method also includes the step of paying for the accepted order as noted above. The user will have the option of paying for the order via the kiosk 16, 116 using electronic methods such as are described herein, or designating through the kiosk that the order will be paid for upon delivery. Preferably, the kiosks are set so as to require payment at the time of ordering. Upon completion of payment, the user is prompted to submit an identification name for the order via the kiosk 16, 116 which also has its own identifier information. The user identification information is input into the kiosk either through use of an alphanumeric keyboard available on the kiosk, a touch screen alphanumeric buttons on the screen, and/or through use of a mouse and/or voice activated software. Alternatively, the ordering software on the kiosk can be modified in accordance with conventional techniques, to generate automatically a random series of numbers corresponding to a specific order, which numbers are displayed for the user on the touch screen when the order is complete and/or can be printed out automatically on a printer attached to the kiosk. At any time after the order is submitted, the user can monitor the status of the order by, for example, submitting the identification name and/or order number into the kiosk 16, 116 through which the order was placed (or depending upon the venue and the transaction server, through any kiosk on the network in communication with the transaction server).

The completed order, having an assigned identification name and/or number is transmitted to the transaction server 20, 120 by the network in communication between the kiosk and the transaction server which server then directs the order information as well as the kiosk identifier to the appropriate preparation area(s) 24, 124 associated with the items listed on the transaction server and displayed on the kiosk via the network. The preparation area(s) chosen are based on the location of the kiosk 16, 116 using the kiosk identifier as well as the items required in the order. Thus, if items available on the kiosk list are not in the closest preparation area, the transaction server would route the order to the next most closest preparation area capable of delivering the items ordered.

The order is received in the preparation area(s) and reviewed by an order preparer via a display device(s) 36, 136 in communication with the transaction server 20, 120. An order preparer may view the order via a display screen 38, 138 or the order may print out from the display device via a printer(s) 40, 140. If various items in the order need to be provided from more than one preparation area, the transaction server routes the order accordingly to the appropriate preparation area. This routing can be done in various ways, for example, all display devices in all relevant preparation areas can display the entire order and each preparation area provide only that item(s) is has available as requested in the order information, or the location for providing the item which is part of the ordering information will only receive the relevant information on display that it is to assemble for pickup as part of an overall order preparation system. These different methods should be understood as conventional in the art of automated food ordering, and so are not discussed further herein. The display device 36, 136 can include a paper printer 40, 140 and/or a display on an electronic screen 38, 138.

The next step in the method is that the entire order is prepared and/or assembled. After preparing and/or assembling the order, the order is delivered to the user in the venue 12, 112 and preferably to the area 28, 128 near or including the kiosk. A delivery person can gather the various items from the indicated preparation areas on the order information provided through the server to the food preparation areas, and/or the order can be pre-assembled from the food preparation areas for the delivery person (or the user directly) to pick up. The user can pick up the food directly by presenting the order number and/or the kiosk identifier and the user's name, thereby delivering the order to himself or herself. The delivery person can also deliver the order using the various delivery methods described herein.

The order is delivered to the user based on the location of the kiosk 16, 116 from which it was sent and the identification name and/or order number or other indicia for the order given by and/or to the user upon completion and acceptance of the order. The delivery person preferably will inquire after each delivery to a user whether any additional service is requested, e.g. napkins, replacement of substandard or incorrect orders, additional order items, etc. Additionally, the delivery person(s) can also be used to fulfill the function of cleaning or “bussing” the venue after each delivery.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A system for a user in a venue to order an item for delivery to the venue, comprising:
at least one kiosk, having a display screen and a computer having software capable of processing an order, the kiosk being located in a limited venue;
at least one seat located in the limited venue;
a network;
a transaction server in communication with the computer in the kiosk via the network; and
an order preparation area having a display device in communication with the transaction server via the network.

2. The system according to claim 1, wherein each kiosk comprises an identifier.

3. The system according to claim 2, wherein the computer software of the kiosk enables users to select at least one item to complete an order to be prepared in the order preparation area.

4. The system according to claim 1, wherein the system further comprises a media server.

5. The system according to claim 1, wherein the network is a wireless network.

6. The system according to claim 1, wherein the network is hard wired.

7. The system according to claim 1, wherein the limited venue is selected from the group consisting of a gate hold area of an airport, a bus depot waiting area, a train station boarding area, a hospital waiting area, or a medical center waiting area.

8. The system according to claim 7, wherein the limited venue is the gate hold area of the airport.

9. The system according to claim 1, wherein the kiosk also comprises an outlet.

10. The system according to claim 1, wherein the system comprises multiple seats having at least one of a row seating arrangement, an arrangement around a table, an arrangement in a form of a pod, a counter seating arrangement, and an individual seat.

11. The system according to claim 10, wherein there are multiple kiosks and seats, and each of the kiosks is available to at least two of the seats.

12. The system according to claim 1, wherein the transaction server is capable of communicating estimated ordering time to the kiosk.

13. The system according to claim 1, wherein the order preparation area provides an item from at least one vendor.

14. The system according to claim 13, wherein the at least one vendor may be a restaurant, gift shop, newsstand and/or a bar.

15. The system according to claim 1, wherein the kiosk further comprises a payment device.

16. The system according to claim 15, wherein the payment device is a magnetic swiping device.

17. A gate hold area, comprising
at least one kiosk, having a display screen and a computer having software capable of processing an order, the kiosk being located in the gate hold area;
and at least one seat located in the gate hold area;
wherein the computer of the at least one kiosk is capable of communicating item ordering information via a network to a transaction server which is also in communication with at least one display device in at least one order preparation area for processing an order transmitted from the at least one kiosk.

18. The gate hold area according to claim 17, wherein the at least one kiosk is also in communication with a media server via a network for providing gate hold information to a user.

19. The gate hold area according to claim 17, wherein the kiosk further comprises an identifier.

20. The gate hold area according to claim 17, wherein the kiosk further comprises a payment device and a receipt printer.

21. The gate hold area according to claim 17, wherein the kiosk further comprises electrical outlets.

22. The gate hold area according to claim 17, wherein the kiosk further comprises software capable of generating sales and revenue data information for communication to the transaction server.

23. The gate hold area according to claim 17, wherein the kiosk has a display screen capable of displaying information from a media server and ordering information from a transaction server.

24. The gate hold area according to claim 17, wherein the kiosk is capable of receiving an estimated order preparation time from a transaction server.

25. The gate hold area according to claim 17, further comprising at least one vendor within the gate hold area.

26. The gate hold area according to claim 25, wherein the at least one vendor is a restaurant, a gift shop, a newsstand, or a bar.

27. The gate hold area according to claim 17, wherein the computer of the at least one kiosk is capable of communicating item ordering information via a network to a transaction server which is also in communication with at least one display device in at least one order preparation area for processing an order transmitted from the at least one kiosk and for transmitting an estimated order delivery time to the at least one kiosk prior to acceptance of an order by a user.

28. The gate hold area according to claim 27, wherein the at least one food preparation area may be located inside or outside of the gate hold area.

29. The gate hold area according to claim 17, wherein the at least one kiosk comprises an identifier and is located in an area of the gate hold area wherein a user waits for an order processed through the kiosk to be delivered.

30. The gate hold area according to claim 17, wherein the gate hold area comprises multiple seats having at least one of a row seating arrangement, an arrangement around a table, an arrangement in a form of a pod, a counter seating arrangement, and an individual seat.

31. The gate hold area according to claim 30, wherein there are multiple kiosks and seats, and each of the kiosks is available to at least two of the seats.

32. A method for a user to order an item in a limited venue for delivery to the limited venue, comprising:
(a) providing a limited venue comprising at least one seat, and at least one kiosk having a display screen and a computer having software capable of processing an order, wherein the kiosk is capable of displaying a selection of items to the user;
(b) selecting an item from the selection of items to complete an order;
(c) transmitting the order from the kiosk via a network to a transaction server;
(d) transmitting ordering information back to the user from the transaction server via the network to the kiosk for acceptance of the order by the user;
(e) submitting the accepted order to the transaction server via the network;
(f) transmitting the accepted order from the transaction server to an order preparation area via the network;
(g) completing the order;
(h) paying for the order; and
(h) delivering the order to the limited venue.

33. The method according to claim 32, wherein ordering information transmitted back to the user in step (d) comprises estimated order delivery time, order item information, and order item cost information.

34. The method according to claim 32, further comprising providing an option to the user to include a gratuity within an overall cost of an order when accepting the order.

35. The method according to claim 32, wherein step (h) further comprises paying for the order via a payment device on the kiosk.

36. The method according to claim 32, wherein step (c) further comprises submitting a kiosk identifier and/or an order identifier and/or user identifier along with item order information to the transaction server from the kiosk via the network.

37. The method according to claim 32, wherein step (f) further comprises transmitting the order information to more than one order preparation area.

38. The method according to claim 32, wherein step (f) further comprises receiving the transmitted order information in the order preparation area via a display device.

39. The method according to claim 32, further comprising providing venue information to the kiosk for user review from a media server.

40. The method according to claim 32, further comprising communicating with the computer in the kiosk via a wireless or remote access source to interface with the computer.

41. The method according to claim 32, wherein the wireless or remote access source is an individual user computer, PDA or wireless phone.

42. The method according to claim 32, wherein the network is wireless.

43. The method according to claim 32, further comprising monitoring status of the order via the kiosk after the order has been accepted.
